(19) United States
(12) Patent Application Publication
(10) Pub. No.: US 2015/0068124 A1
(43) Pub. Date: Mar. 12, 2015

(54) SUPPORT AND OPERATING DEVICE OF SLIDING DOORS, IN PARTICULAR FOR WARDROBES

(71) Applicant: TERNO SCORREVOLI SRL, Varedo (MB) (IT)

(72) Inventor: Paolo Fornasari, Cordenons (PN) (IT)

(21) Appl. No.: 14/394,994

(22) PCT Filed: Dec. 6, 2012
(86) PCT No.: PCT/EP2012/005054

§ 371 Date: Oct. 16, 2014

(30) Foreign Application Priority Data
May 29, 2012 (IT) PN2012A000026

(51) Int. Cl. E05D 15/10; A47B 61/00; E06B 3/50; E05D 15/08; E06B 3/46

(52) U.S. Cl. CPC E05D 15/10; E05D 15/08; E06B 3/4636; E06B 3/5045; A47B 61/003
USPC 49/130

(57) ABSTRACT

Support and operating device for sliding doors, in particular for wardrobe cabinets, wherein the doors (6) are moved from a closed and lowered position, to an open and raised position, shifted forward in relation to the closed doors, and vice versa. The device comprising one upper group of component parts and one lower group of component parts for each door (6), suitable for determining the movement of the door in such a way that it is always kept in its correct parallel and orthogonal position in all the shifted positions thereof.

The invention relates to a support and operating device for sliding doors, in particular for wardrobe cabinets, the doors of which are made of the type sliding in an alternate longitudinal direction along upper and lower rectilinear guides, attached respectively to the bottom and top of the relative cabinet, and such doors are operated in alternate longitudinal directions of sliding in positions coplanar to each other, from the open position to the closed position, and vice versa.

Support and operating devices of sliding doors for cabinets are known of, the doors of which are fitted with wheels sliding in an alternate longitudinal direction along two relative rectilinear guides, which are attached parallel to each other respectively at the bottom and at the top of each cabinet, and appropriately distanced from each other in the direction of the depth of the cabinet, so that each door can slide along the respective guides, parallel to the other door and to the front of the cabinet, independently of the other door. This widespread system of opening and closing the cabinet doors, despite being practical and space-saving in that the doors do not rotate around hinges but slide in an alternate longitudinal direction in parallel positions to each other, does not permit a front wall of flat and uniform doors to be achieved, thereby determining an unattractive aesthetic effect.

Support and operating devices of sliding doors for cabinets are also known of, the doors of which also slide in an alternate direction, no longer in parallel positions but in coplanar positions to each other, so that in the closed position of the doors a flat, uniform front wall is obtained, aesthetically pleasing and appreciable. In these opening and closing systems of the cabinet doors, the doors are no longer operated separately from each other, but are operated in symmetrical directions to each other, and move from a closed position in which they are in a slightly recessed position in the direction of depth of the cabinet, and parallel to each other, to an open position in which they are first shifted forwards by a limited stroke and then made to slide laterally into the desired position, parallel to the front face of the cabinet, along rectilinear guides attached to the top and to the bottom of the cabinets. To such purpose, the support and operating devices of the doors are shaped so that the right side of the doors always moves together with the left side of the doors, and so that this synchronism is also ensured between the upper and lower part of such doors. The currently existing support and operating devices are made using systems of levers and tie-rods that act on carriages which, by means of particular profiles, support the doors and determine the sliding guides for the door shifted forwards and predisposed for alternate lateral sliding. The present invention sets itself the task of making a support and operating device for sliding doors, in particular for wardrobe cabinets, suitable for still determining the operating of the doors with a forward movement and alternate lateral sliding, as currently occurs for doors coplanar with each other in a closed position, while using however simpler and cheaper construction and assembly mechanisms than those currently utilised.

This support and operating device is made with the construction characteristics substantially described, with particular reference to the appended patent claims.

The invention will be more clearly comprehended from the following description, made by way of a non-limiting example and with reference to the appended drawings, wherein

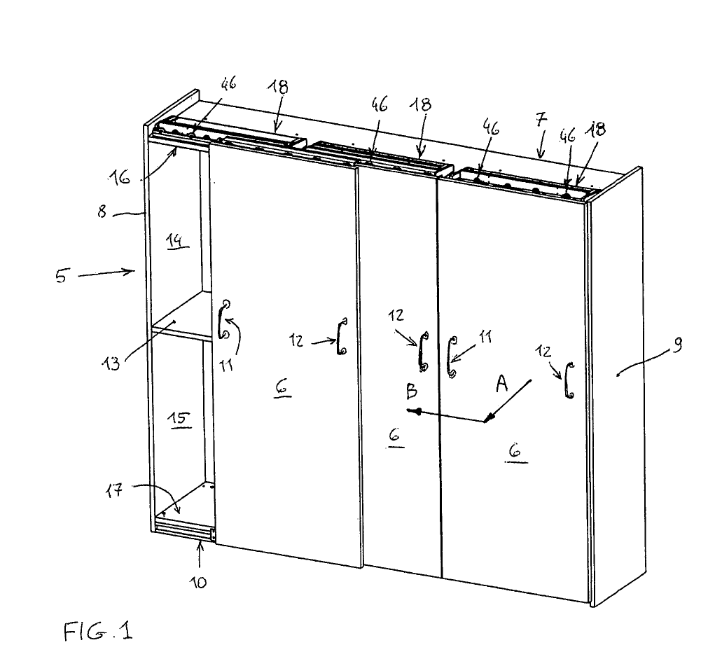

FIG. 1 shows a front perspective view of a cabinet incorporating the support and operating device according to the invention, with one door moved to the open position and two doors moved to the closed position;

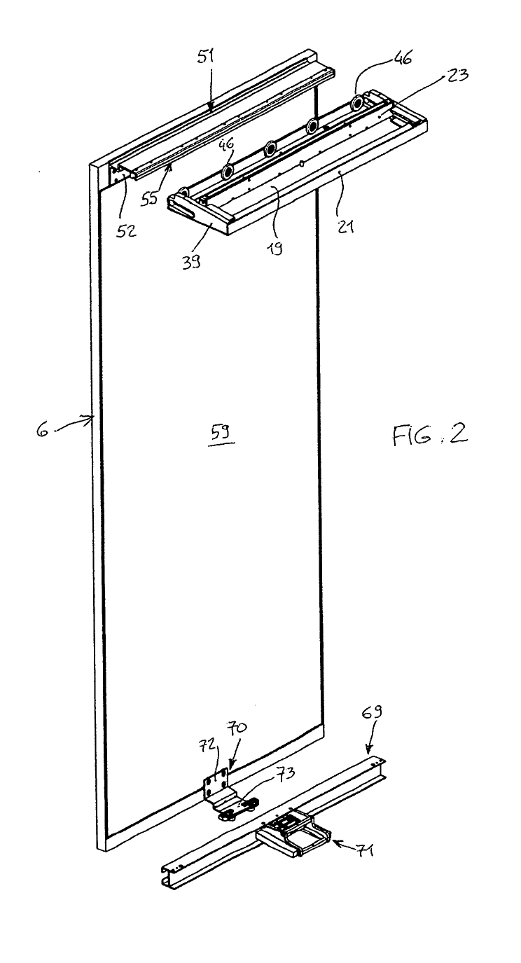

FIG. 2 shows a rear perspective view of a door of the cabinet in FIG. 1, with the relative component parts fitted permitting the longitudinal sliding thereof;

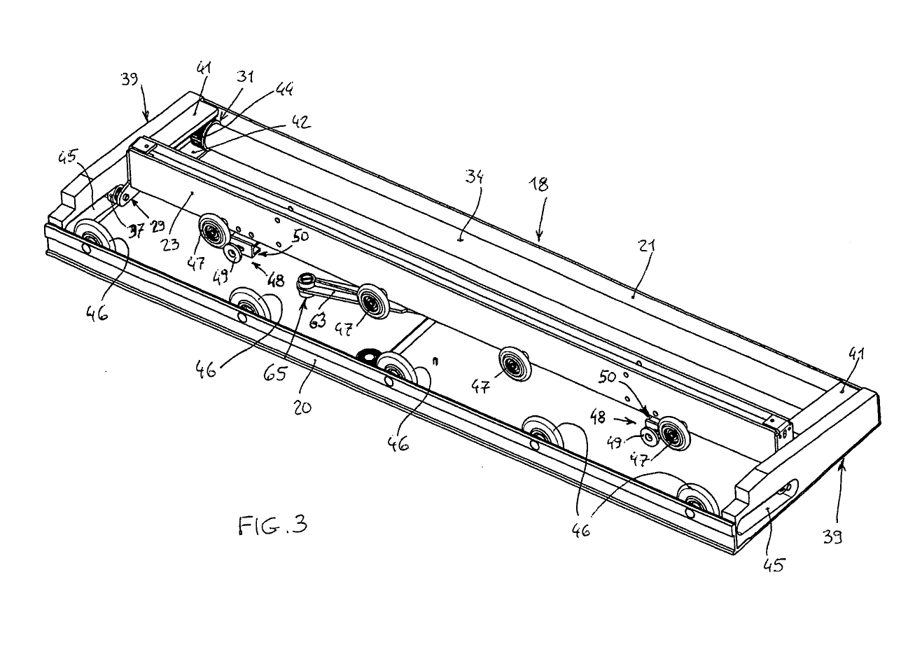

FIG. 3 shows a perspective view from above and in front of the upper group of component parts of a door of the cabinet in FIG. 1;

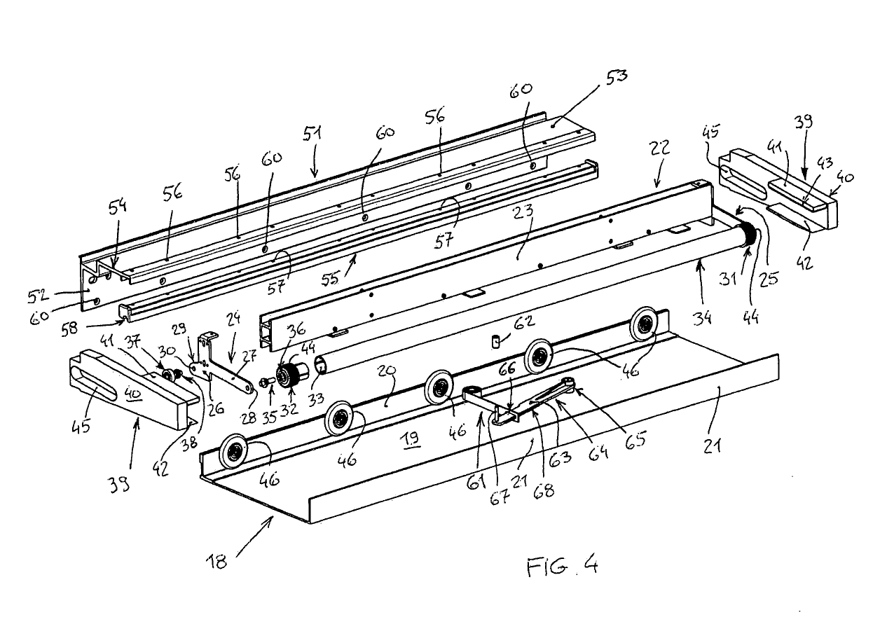

FIG. 4 shows an exploded and rear perspective view of the component parts of the upper group of the door in FIG. 3;

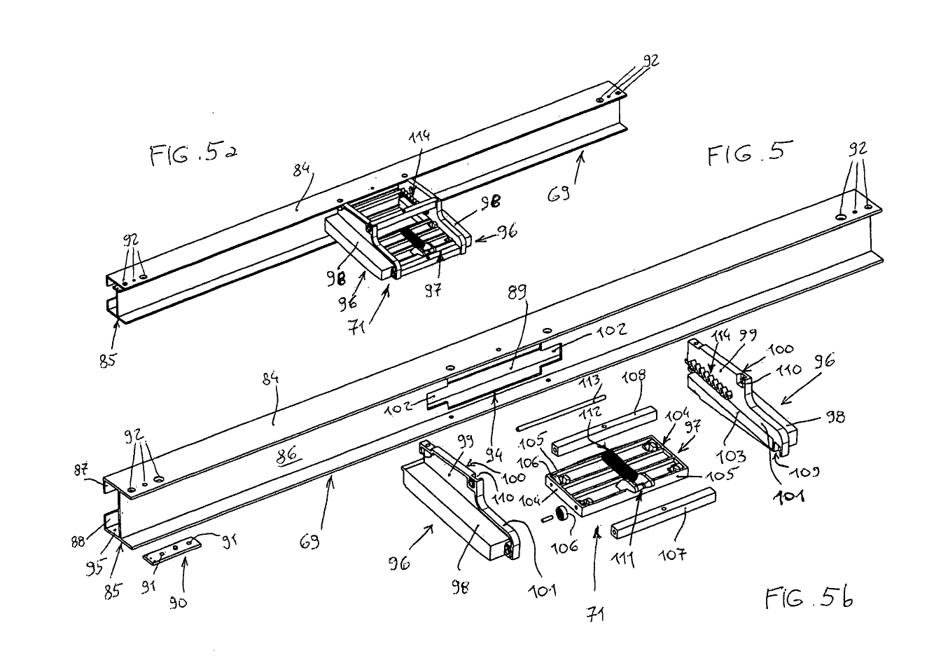

FIG. 5 shows an exploded and frontal perspective view of the lower group of component parts of a door of the cabinet in FIG. 1;

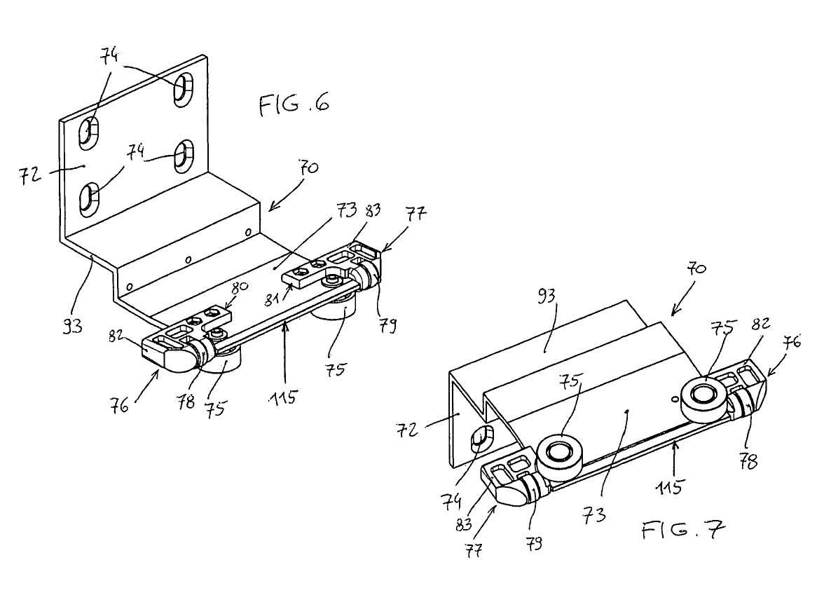

FIGS. 6 and 7 show a perspective view respectively from above and below of one of the component parts of the lower group in FIG. 5, detached from such lower group;

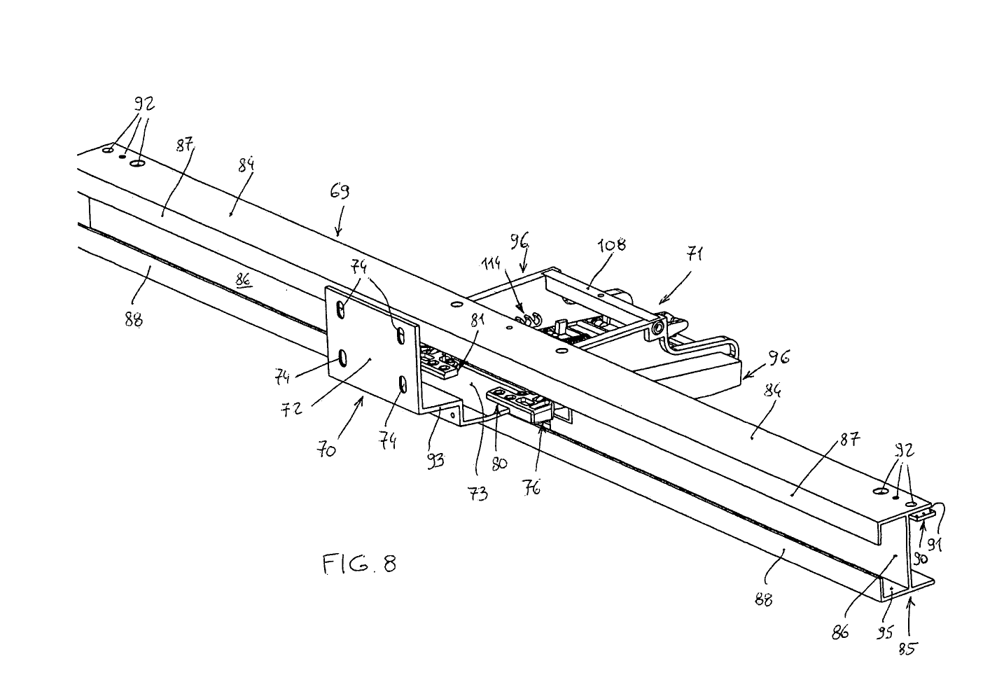

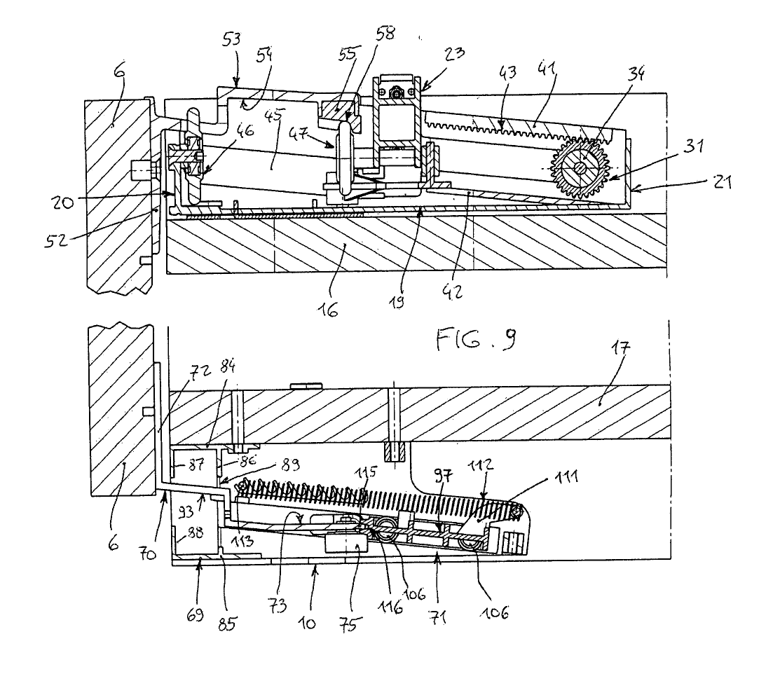

FIG. 8 shows a front perspective view of the component part in FIGS. 6 and 7, fitted to the lower group in FIG. 5;

FIG. 9 shows a cross-sectioned view in a longitudinal direction of the upper group and of the lower group of component parts of a door of the cabinet, moved to the closed position;

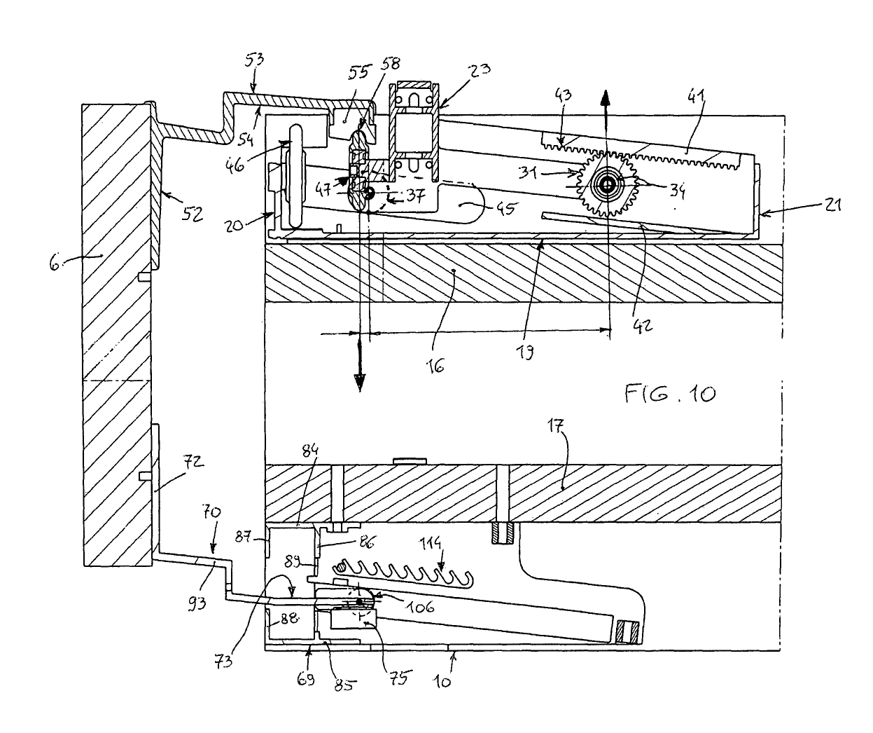

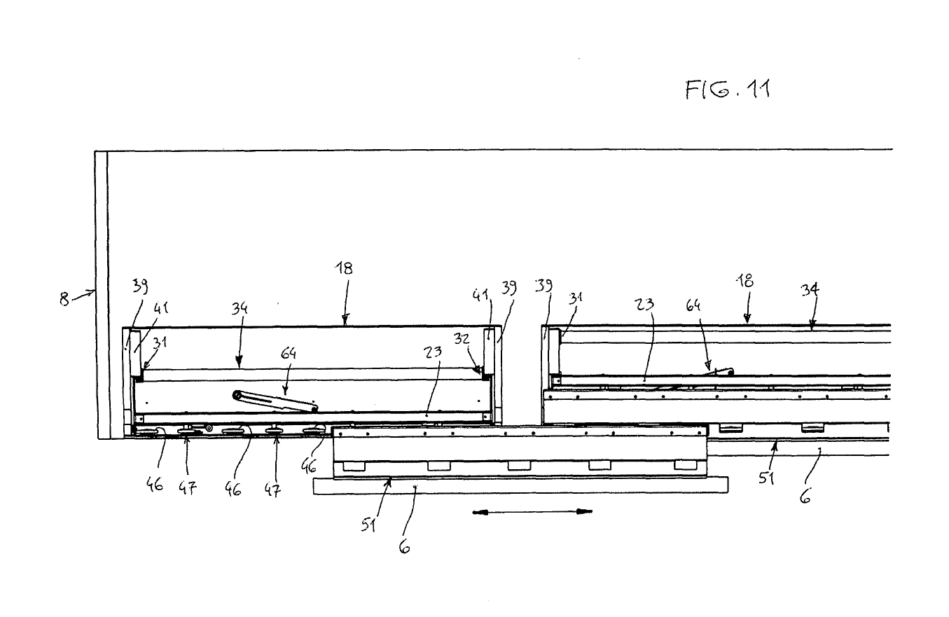

FIG. 10 shows, in the same view as FIG. 9, the door moved to a partially open or closed position;

FIG. 11 shows a ground view of the upper part of two doors adjacent to each other, one of which is shifted forward to be moved to the open position, and the other of which is moved to the closed position;

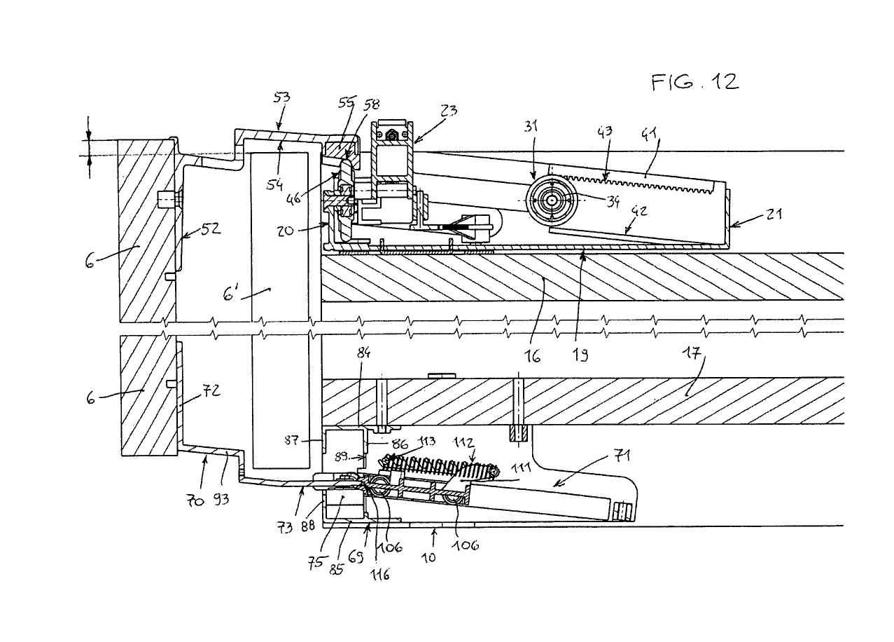

FIG. 12 shows, in the same view as FIG. 9, the door moved to an open position. In the aforesaid drawings, a support and operating device of sliding doors, in particular for cabinets according to the present invention is represented, constructed and functioning in the manner which will be described and suitable for determining the support and operating and sliding of the doors in alternate longitudinal directions in positions coplanar to each other, wherein the doors are operated so as to shift from a closed position in which they are adjacent and aligned with each other and in relation to the front of the cabinet, to an open position in which they are first shifted forwards by a limited stroke and then made to slide laterally into the desired position, parallel to the front face of the cabinet, and vice versa.

In particular, FIG. 1 shows a cabinet 5 fitted with front doors, in the example composed of three flat doors 6 identical to each other and each incorporating the present support and operating device of the doors, while FIG. 2 shows a door 6 fitted with the relative component parts of the present device permitting the longitudinal sliding thereof. In FIG. 1 it may be noted that the cabinet 5 is delimited by a flat rear back 7, parallel to the doors 6, by two lateral flat sides 8 and 9, parallel and distanced from each other in a longitudinal direction, by a distance slightly greater than the length of the three doors 6, by a flat upper top (not shown), attached above the doors 6, to the back 7, and to the sides 8 and 9, and by a flat lower bottom 10, parallel to the top and distanced from the same by a distance slightly greater than the height of the doors, as well as being attached under the doors 6 to the back 7 and to the sides 8 and 9. The doors 6 are fitted with handles such as for example two lateral handles 11 and 12, to move said doors from the closed position to the open position and vice versa.

In the same figure it may also be noted that the central doors and right side door are moved to the closed position, in which they are adjacent and aligned with each other, while the left side door is moved to the open position, in which it is moved to the front of the closed doors, and parallel thereto, thereby making the inner space inside the cabinet accessible, which in the example illustrated is divided by an intermediate horizontal shelf 13 into an upper half space 14 and a lower half space 15.

In the cabinet thus shaped, in each door 6 a support and operating device of the door according to the invention is fitted, which is composed substantially of an upper group of component parts and of a lower group of component parts, made as will be described, of which the upper group is installed and attached in a free upper space of the cabinet 5, delimited between the relative overlying top portion of the cabinet itself and a horizontal shelf 16, attached between the lateral sides 8 and 9 and composing the upper wall of the upper half space 14 of the cabinet.

In turn, the lower group is installed and attached in a lower free space of the cabinet 5, delimited between the relative underlying bottom portion 10 of the cabinet itself and an overlying horizontal shelf 17, defining the end wall of the lower half space 15 of the cabinet. In FIGS. 3 and 4 each upper group of the support and operating device of the relative cabinet door will now be described in detail, which is substantially composed of a metal, box-like structure 18 formed of a flat bottom base 19, which may be the same length or not as the relative door 6 and have a slightly lesser depth than the corresponding portion of the free upper space, said bottom base 19 being orthogonally bent along its longitudinal sides, thereby forming respectively a flat front rim 20 and a flat rear rim 21 identical to each other. The box-like structure 18 thus realised is suitably attached above the horizontal shelf 16, in the position corresponding to each door 6. In the rear part of the flat bottom 19 a sliding or mobile carriage 22 is housed formed of an elongated profile 23 of a parallelepiped shape, being shorter in length than the length of the bottom base 19 and of limited width, said elongated profile being attached at its ends to a first and a second flat profile element 24 and 25, identical to each other, each of which is shaped with a central body 26 having a vertical extension, adaptable and attachable by means in themselves known against the corresponding end of the elongated profile 23, and with a lateral horizontal arm 27 forming a 1st class lever arm, projecting from the central body 26 in a rear direction of the flat bottom 19, as well as fitted with a through hole 28 at its end, each flat profile element described lastly being shaped with a short lateral protrusion 29, fitted with a through hole 30 and projecting from said central body in the opposite direction to that of the horizontal arm 27, for the reason described below. Such profile elements 24 and 25 are attached against the ends of the elongated profile 23, so that both horizontal arms 27 face the rear rim 21 of the bottom base 19 and their short protrusion 29 faces towards the front rim 20 of said bottom base, thence between the horizontal lever arms 27 of both said profile elements, a first and a second toothed reel 31 and 32 of reduced diameter, identical to each other, are applied and attached, which in turn are inserted and attached inside the relative lateral cavities 33 of a rigid torsion bar, preferably metal 34, of an elongated cylindrical shape, which is housed in the longitudinal direction of the bottom base 19, for almost its entire length and slightly detached from it, so that such torsion bar 34 can be operated in rotation, together with the relative toothed reels 31 and 32, in both its directions of rotation, in the manner and for the purpose described below. As can be seen, each toothed reel 31 and 32 is attached in a non-motorised manner against the relative end of the torsion bar 34, by inserting a bolt or screw 35 through the through hole 28 of the horizontal arm 27 and screwing the same into a corresponding threaded hole 36 of the relative toothed reel. In turn, the lateral protrusions 29 support in a non-motorised manner, a relative slide wheel 37 which is attached with its short threaded stem 38 against the outer side of such lateral protrusions 29, inserting such threaded stem 38 through the corresponding through hole 30, which is threaded, of the relative lateral protrusion. Lastly, each end of the sliding or mobile carriage 22 thus assembled is supported as will be described, by a corresponding side 39 shaped, for example by die-casting metals or moulding thermoplastic materials, which are identical to each other and are opportunely attached laterally against the box-like structure 18.

The shaped sides 39 are each shaped with a flat outer surface 40 and with an inner surface fitted with two short rectilinear protrusions 41 and 42, parallel and slightly distanced from each other, made at the relative toothed reels 31 and 32, in the rear part of the flat bottom 19.

Such rectilinear protrusions 41 and 42 are fitted with a plurality of teeth 43 facing each other, and having a profile and size identical to that of the teeth 44 of both the toothed reels 31 and 32, and these rectilinear protrusions are moreover distanced from each other by an interval such as to permit the insertion between them of the toothed reels 31 and 32, so that during this operation the teeth of the latter mesh with the corresponding teeth of said protrusions.

Each of the lateral sides 39 is moreover shaped, in the part facing towards the front of the flat bottom 19, with an elongated through slot 45, which is inclined upwards in relation to the horizontal plane of said flat bottom, and this slot is sized to slidingly house the relative slide wheel 37 of the lateral protrusion 29, forming with it an inclined plane for the sliding of said side wheel with a short stroke defined by the corresponding through slot 45. By means of this arrangement, the sliding or mobile carriage 22 thus assembled can be moved manually in the lateral direction of the box-like structure 18, from one to the other of the end-stop positions defined by the ends of the through slot 45, and during this movement the rotation of the toothed reels 31 and 32 in relation to the respective toothed rectilinear protrusions 41 and 42, which are fixed, is determined, with a consequent rotation of the torsion bar 34 and siding of the slide wheels 37 along the corresponding inclined through slots 45. Such sliding or mobile carriage 22 can thus be moved from a position in which the torsion bar 34 is positioned next to the rear rim 21 of said box-like structure 18 (see FIG. 3), in the condition in which both slide wheels 37 are housed in the lower end of the relative through slots 45, and therefore the carriage 22 is lowered and next to the flat bottom 19 of such box-like structure 18, to a position in which the torsion bar 34 is positioned next to the front rim 20 of said box-like structure 18, in the condition in which both slide wheels 37 are housed in the upper end of the relative through slots 45, and therefore the carriage 22 is raised and distanced from the flat bottom 19 of such box-like structure 18. Inside the front rim 20 of the box-like structure 18 various non-motorised rotating wheels 46 are pivoted, identical and aligned and distanced from each other by the same interval in a longitudinal direction of said box-like structure, and suitable for being housed and rotating inside corresponding rectilinear and longitudinal guide elements (not shown), which are made and attached to the upper part of each door 6 as described below. In addition, in the front side of the elongated profile 23, facing the front rim 20 of the box-like structure 18, various non-motorised rotating wheels 47 are pivoted, identical and aligned and distanced from each other by the same interval along such front rim 20, the wheels of which are pivoted in staggered positions in a longitudinal direction in relation to the positions in which the wheels 46 are pivoted, and are positioned parallel to the wheels 46.

Beside the wheels 47 situated in the end positions, an end stop 48 is respectively placed, composed of a relative disc 49 in soft material such a plastic, rubber etc, which is supported by a relative metal bracket 50 attached under the elongated profile 23. Each end-stop disc 49 faces towards the opposite inner surface of the front rim 20 of the box-like structure 18 and projects slightly beyond the wheels 47, as well as being positioned parallel to such inner surface, this way when the sliding or mobile carriage 22 is moved into the rear end-stop position, see FIG. 3, all the wheels 47 and all the end stop discs 49 are shifted in a transversal direction to both the aforesaid front rim 20 and to the relative wheels 46, this way when the sliding or mobile carriage 22 is moved into the forward end-stop position, see FIG. 11, all the wheels 47 are aligned and interposed between the wheels 46 and all the end stop discs 49 abut against the inner surface of the front rim 20, thereby dampening the impact between these component parts. In this last shifted position of the sliding or mobile carriage 22 therefore all the wheels 46 and 47 aligned with each other can be housed and rotate inside the aforesaid rectilinear and longitudinal guide elements attached to the door 6, for the reason described below.

With reference to FIG. 2 and to FIG. 4 it may be noted that each door 6 is fitted in the cabinet 5 by means of an elongated weight-bearing profile 51 having the same length as the door and shaped to adapt to and be attached above the same. For this purpose, such elongated weight-bearing profile 51 is square-shaped defining a flat rectilinear front side 52 extending in a vertical direction, and an upper rectilinear horizontal side 53, bent orthogonally in relation to the front side 52 and having an identical width to the length of the through slots 45 and therefore to the length of the stroke of the sliding or mobile carriage 22 in the transversal direction of said box-like structure 18.

Such horizontal upper side 53 is bent all along its length so as to define a recessed zone 54 facing downwards, the end portion of which is shaped to support a corresponding longitudinal rectilinear profile 55, constituting a rectilinear and longitudinal guide element, which is attached under said end portion by means of bolts, screws and the like (not shown), inserted through corresponding through holes 56 and 57 of the end portion and of the guide element described. Such longitudinal guide element 55, moreover, is shaped underneath with a groove 58 all along its length, having a curved profile such as to house only the wheels 47 of the sliding or mobile carriage 22, when the latter is moved into its rear end-stop position, and to house such wheels 47 and also the wheels 46 of the box-like structure 18, when this carriage 22 is moved into its forward end-stop position.

The installation of the door in position is performed, as seen in FIG. 2, by arranging in succession the front side 52 of the weight-bearing profile 51 against the upper part of a cover panel 59, adaptable and attachable against the rear surface of the door 6, thence attaching such front side 52 against the panel 59 by means of screws and the like (not shown), inserted through the through holes 60 of said front side and screwed into the aforesaid panel 59, so that the weight-bearing profile 51 is positioned and attached above the panel 59 in a horizontal arrangement.

Subsequently the panel thus fitted is applied and attached suitably against the rear surface of the door 6, so that the front side 52 of the weight-bearing profile 51 is positioned between the rear surface of the door and the front surface of the panel 59, and the horizontal side 53 of the weight-bearing profile 51 is facing towards the box-like structure 18 and the sliding or mobile carriage 22. With this installation arrangement, therefore, the door 6 is supported and moved by the sliding or mobile carriage 22 in the transversal direction of the box-like structure 18, thanks to the constant engagement of the wheels 47 of said carriage in the groove 58 of the guide element 55, and in this manner the door 6 can thus be moved by such carriage from the rear end-stop position of the carriage, in which the door is lowered and moved into the closed position, to the front end-stop position of the carriage, in which the door is slightly raised and moved into the open position, positioning itself on the front parallel to the other closed doors, and vice versa.

FIG. 1 shows a cabinet 5 with the central doors and right door moved to the closed position, in which such doors are aligned with each other and with the left door moved to the open position.

In this condition then, each door 6 is opened by pulling it to the front in the direction A, using the handles 11 and 12, as far as the front end-stop position of the carriage 22, then such door is made to slide on the front of the closed doors, as far as the desired position, in the example in the direction B, in that the sliding is permitted by the presence of corresponding identical box-like structures 18 attached to the back of each door 6 of the cabinet 5, and positioned adjacent and aligned with the remaining box-like structures of such cabinet, so that in this case the guide element 55 of such open door is aligned with the wheels 46 of the box-like structure 18 respectively adjacent, and therefore the sliding of this door is determined by the position and rotation of these wheels 46 in the groove 58 of such guide element 55. When each door to be opened is moved to the front in the direction A, such door is always kept perfectly parallel and orthogonal by a balancing spring 61, one end of which winds and unwinds around a pin 62 attached under the elongated profile 23, and the other end of which is constrained to the arm 63 of a lever 64, hinged by means of a pin 65 onto the flat bottom 19 of the box-like structure 18. In the drawing it may be noted that the constraint between the spring 61 and the lever arm 63 takes place by inserting the latter through a through hole 66 of the spring 61, however this may be achieved in a different manner while remaining within the sphere of protection of the invention. In turn, such arm 63 is provided with a projecting lock 67 at its end to prevent the extraction of said spring 61 from the arm and presents a series of notches 68 positioned close together, to constrain the end of the spring in various positions along the arm, thereby varying the tension of the spring depending on the weight of the door 6 to be balanced each time. This way, during the movement of the door 6 towards its open position, the consequent sliding of the carriage 22 towards the front end-stop position pulls with it the end of the spring 61, which is preferably of the “constant force” type, suitable for contributing to the balancing of the door, so that such spring 61 is unwound from its pin 62 and exerts against the door 6 a force opposing the direction of movement of such door 6, which helps to maintain a correct orthogonal and parallel position of the door 6 in all the shifted positions thereof as far as its complete aperture.

The same situation also occurs during the movement of the open door 6 towards its dosed position, in such case by means of rewinding of the spring 61 onto its pin 62, and balancing of the door with an opposing force constant in relation to the closing force of the door, due to the weight of the same on the inclined plane. This guiding and balancing effect exercised on the upper part of the door by the spring 61, during its opening or closing movement, is also exercised on the lower part of the door by the lower group of component parts of the present support and operating device, shown in FIGS. 2 and 5-8, which is made and functions as described below.

As is visible in FIGS. 2 and 5, this lower group is substantially composed of a rectilinear longitudinal profile 69, having the same width as the door 6 and which is applied to the flat lower bottom 10 and attached under the horizontal shelf 17 of the cabinet 5, at each door, by a shaped bracket 70 which is attached to the lower central part of the door 6, and by a mobile carriage 71 co-operating with the longitudinal profile 69 and with the shaped bracket 70 as will be described below. In particular, the bracket 70 (see FIGS. 6 and 7) is shaped with a flat vertical side 72, which connects by a series of steps orthogonally to a flat horizontal side 73, wherein such vertical side 72 is fitted with various through holes 74, for the insertion of screws, bolts or the like (not shown) for the attachment of the bracket 70 against the rear surface of the door 6, above the cover panel 59, so that the horizontal side 73 is facing towards the cabinet 5.

At the front rim of the horizontal side 73, two sliding wheels 75 with a vertical axis, identical to each other and mounted free in rotation, are fitted laterally and from below, in an aligned position with each other in a transversal direction of the side 73, so as to slide in a longitudinal direction along the longitudinal rim 69 of each door 6, in the manner and for the purpose described below. Moreover, two support plates 76 and 77 identical and symmetrical to each other are applied and attached laterally to the upper surface of the horizontal side 73, to support a relative wheel 78 and 79 with horizontal axis, identical to each other and suitable for sliding in the transversal direction of the cabinet 5, in the manner and for the purpose which will be described.

The support plates 76 and 77 are shaped in one piece respectively with a flat appendix 80 and 81, and with a shaped piece 82 and 83, projecting from the relative lateral rim of the bracket side 73, in which the appendixes 80 and 81 are attached to the upper surface of such bracket side 73, while the projecting pieces 82 and 83 are shaped so that their horizontal wheels 78 and 79 are supported freely in rotation and are parallel to each other.

In turn, as visible in FIGS. 5 and 8, the longitudinal profile 69 is shaped as a double T, defined by a flat and horizontal upper side 84, and by a flat and horizontal lower side 85, which is identical and positioned parallel to the aforesaid upper side, as well as joined to it by a vertical and central side 86. In turn, the upper side 84 of the profile 69 is bent downwards at the front by means of two short flat flaps 87 and 88 facing each other and defining between them a free space which, when the bracket 73 is coupled to such profile 69, permits the longitudinal sliding of the bracket along this free space, all as will be described.

In its central area, the longitudinal profile 69 is fitted with a through aperture 89, shaped and scaled for the insertion of both the shaped bracket 70 and the mobile carriage 71, as visible particularly in FIGS. 5, 8, 9, 10 and 12. In these figures moreover, it can be seen that the longitudinal profile 69 is attached with its flat upper side 84 and with its flat lower side 85 respectively under the horizontal shelf 17 and over the bottom 10 of the cabinet, and in the figures considered it may be noted that such upper side 84 is attached under the shelf 17 by means of two corresponding flat plates 90, which are arranged under the rear end portions of the upper side 84 of the profile 69, using screws, bolts or the like (not shown) which are inserted and screwed into position passing through corresponding through holes 91 and 92 of the plates 90 and of the upper side of the profile 84, while in turn the lower side 85 of the profile 69 is positioned above the bottom 10 of the cabinet.

The lower group thus composed creates the support for the door 6, firstly applying the bracket 70 against said door as described above, then inserting the horizontal side 73 of the bracket 70 through the through aperture 89 of said profile 69, so that the vertical wheels 75 and the horizontal wheels 78 and 79 mounted in this bracket side 73 are completely inserted in the free lower space of the cabinet 5, defined between said horizontal shelf 17 and said bottom 10, and that such bracket side 73 may co-operate with the mobile carriage 71 as will be described.

In this condition then, the inclined step 93 of the bracket side 73 is distanced from the lower rim 94 of the through aperture 89 of the profile 69 (see 4.9), when the door is moved to the closed position, while the mobile carriage 71 is moved to its rear end-stop position, in which it is completely housed inside the aforesaid free space.

Such bracket side 73 is then moved outwards, progressively raising itself, gradually as the door is moved outwards towards its open position and vice versa, such bracket side 73 returns progressively from the raised position, when the door is open, to the lowered position gradually as the door is moved to its closed position.

FIG. 10 shows the door 6 moved to a partially open (or partially closed, depending on the direction of movement of the door) position, wherein the inclined step 93 is distanced from the through aperture 89 of the profile 69, while the bracket side 73 is partially extracted from said through aperture, in the condition in which the vertical wheels 75 and the horizontal wheels 78 and 79 of such bracket side 73 are positioned next to but not corresponding to the position of the lower free sliding space of the profile 69, while the mobile carriage 71 (not shown in the drawing) is distanced from the previous rear end-stop position and moves towards its front end-stop position. FIG. 12 shows the door 6 moved to the completely open position, in which the bracket side 73 is completely extracted from the through aperture 89 of the profile 69, in the condition in which the vertical wheels 75 and the horizontal wheels 78 and 79 of such bracket side 73 are placed in a position corresponding to that of the aforesaid free sliding space, in which the vertical wheels 75 are housed inside said free space and distanced from the flat bottom 95 thereof, while the horizontal wheels 78 and 79 are also housed in said free space and rest against the opposite outer surface of the vertical side 86 of the profile 69, and in turn the mobile carriage 71 is moved into its front end-stop position. In this condition then, such bracket side 73 may be moved in the alternate longitudinal direction of the profile 69, together with the door 6, thanks to the guided sliding of said bracket side determined by the sliding of said vertical wheels 75 and horizontal wheels 78 and 79 along the free sliding space of the longitudinal profile 69, while in turn the mobile carriage 71 remains stationary in its front end stop position.

The mobile carriage 71 of the lower group will now be described with particular reference to FIG. 5a which shows said mobile carriage coupled to the longitudinal profile 69, and to FIG. 5b which shows the mobile carriage 71 with all its component parts separate from each other and detached from the profile 69. As is visible, the mobile carriage 71 is substantially composed of two lateral sides 96 identical and symmetrical to each other, suitable for being coupled to the through aperture 89 of the elongated profile 69, and of a central horizontal frame 97 suitable for being coupled between the sides 96, so as to slide with a limited stroke along the same. The lateral side 96 are shaped with a respective outer portion 98 of a parallelepiped shape, projecting horizontally, and with a respective inner portion 99, extending in a vertical direction and profiled with a raised portion 100 and with a lowered portion 11, connected to said raised portion. The relative projecting horizontal portions 98 are scaled so as to adapt and be suitably attached with one end in the corresponding widened area of the through aperture 89, so that the sides 96 are kept parallel to each other, while the relative inner portions 99 are provided with a corresponding inclined inner groove 103, which face each other and are made with the same inclination and same length as the through slots 45 of the upper group described above. Such inclined grooves 103 respectively present an open end, facing towards the elongated profile 69, and a closed opposite end made at the terminal end of each inner portion 99, and these ends respectively define the front end-stop and the rear end-stop of the central frame 97 of the mobile carriage 71. To such purpose, the central frame 97 is made in a quadrangular shape defined by two thin sides 104, parallel to each other and extending in a longitudinal direction of the mobile carriage 71 and by two further sides 105 parallel to each other and joined to the previous sides as well as extending in a transversal direction of the mobile carriage 71. In the outer part of the longitudinal sides 104 of the frame 97 a pair of non-motorised wheels 106 are respectively pivoted, with a horizontal rotation axis, identical to each other and suitable for being inserted so as to slide in the corresponding inclined grooves 103 of the sides 96, so as to permit the sliding of the frame 97 in relation to such sides. The assembly of the frame 97 to the sides 96 is completed using a rear horizontal bar 107 and a front horizontal bar 108, the first of which is attached between two lower notches 109 of the sides 96, at the rear side of the frame 97 and acts as an abutment for the latter in its rear end-top position, a the second of which is attached between corresponding upper notches 110 of the sides 96, at the front side of the frame 97 and acts as an abutment for the latter in its front end-stop position. The frame is further provided with a fixed attachment 111 attached in its rear side 105 and to which the end of a longitudinal traction spring 112 couples, the other end of which couples to a rod 113 which is inserted in corresponding cavities of a series of inclined teeth 114, made projecting from the inner surfaces of the inner portions 99 of the sides 96, and aligned with each other in a parallel position above the relative inclined groove 103 of said sides. Lastly, the front side 105 of the frame 97 is shaped to be coupled to the end rim 115 of the flat side 73 of the bracket 70, when the door 6 is moved in relation to the mobile carriage 71 so that these parts come to coincide with each other, and such coupling is obtained in the example shown by a detachable engagement of such rim 115 in a corresponding cavity 116 of the front side of the frame. In this condition then, the door 6 can be moved from the open position to the closed position and vice versa.

This way the central frame 97 of the mobile carriage 71 is always moved by the movement of the bracket 70 into the same shifted position of the latter, and during each movement of the bracket 70 it is stressed by the force of the spring 112, which helps the balancing of the door during the movement thereof from the closed position to the open position and vice versa. This force exercised by the spring 112 (and also by the upper spring 61) tends to open the door 6, in that without these springs 112 and 61 the door would tend to close on account of its weight, thereby reducing the force exerted By the user to open the door 6. In both conditions however such force of the spring 112 (and of the spring 61) assists the shifting movement of the door, which is always kept in its correct parallel and orthogonal position, thanks to the fact that the sliding of the lower part of the door 6 is guided by the sliding of the guide 97 of the mobile carriage 71 along the inclined grooves 103 of the sides 96, and the sliding of the upper part of the door 6 is guided by the sliding of the wheels 37 in the through slots 45, and that such sliding always take place in synchrony with each other and in the same sliding positions along the respective sliding paths. The tension of the spring 112 may be varied, depending on the balancing needs, moving said rod 113 each time into a corresponding cavity of the inclined teeth 114.

When the door 6 has been moved to the completely open position (see FIG. 12), wherein the bracket side 73 is aligned with the free sliding space of the profile 69, as already described above, the door 6 is moved in an alternate longitudinal direction along this profile 69, detaching the end rim 115 of the bracket side 73 from the cavity 116 of the front side of the frame.

FIGS. 9, 10 and 12 show the various positions which the door 6 can be moved into in the cabinet incorporating this support and operating device.

FIG. 9 shows the door 6 moved into the lowered closed position, in which the mobile carriage 71 is shifted into its rear end-stop position, and is coupled as described with the bracket 70 attached underneath in the door, and in this condition the spring 112 is completely taut keeping the mobile carriage 71 in this rest position, while in turn the door 6 is positioned close to and parallel to the front face of the cabinet and the wheels 37 also of the upper sliding or mobile carriage 22 are moved into the through slots 45 in the same rear end-stop position, which is aligned and coinciding in a vertical direction with the position of the mobile carriage 71.

In this position, moreover, the bracket side 73 is completely inserted in the lower free space of the cabinet, in which the vertical wheels 75 and the horizontal wheels 78 and 79 of such bracket side 73 are shifted in relation to the free sliding space of the profile 69, so that the door 6 cannot be made to slide in an alternate longitudinal direction.

FIG. 10 shows the door 6 moved to a partially open (or partially closed, depending on the direction of movement of the door) position, which has been described above, in which the spring 112 is partially taut (not shown in the drawing), and the frame 97 of the mobile carriage 71 is shifted along said inclined groove 103 in a raised positioned compared to the initial rest position and is still aligned and coinciding in a vertical direction with the position of the wheels 37 of the upper sliding or mobile carriage 22, with consequent shifting to the front of the door 6, which is always kept in the correct parallel and orthogonal position. In this shifted position of the door 6, moreover, the bracket side 73 is still coupled to the mobile carriage 71 and is partially inserted in the lower free space of the cabinet, in which the vertical wheels 75 and the horizontal wheels 78 and 79 of such bracket side 73 are still shifted in relation to the free sliding space of the profile 69, so that the door 6 as previously cannot be made to slide in an alternate longitudinal direction. Lastly in FIG. 12 the door 6 is seen moved into the fully open position, already described above, in which the mobile carriage 71 is shifted to the front end-stop position, and is still coupled to the bracket 70, the side 73 of which is aligned and coinciding with the free sliding space of the profile 69, in the condition in which the spring 112 is fully distended, and the door 6 can therefore be made to slide in an alternate direction along the profile 69, using the handles 11 and 12 thereof.

In this open position of the door, moreover, the same is still kept in a parallel and orthogonal position, thanks to the fact that the wheels 37 of the upper sliding or mobile carriage 22 are also shifted into the through slots 45 in the same front end-stop position, which is aligned and coinciding in a vertical direction with the position of the mobile carriage 71. When the door is made to slide along the profile 69 in the desired direction, the end rim 115 of the bracket side 73 is disengaged from the cavity 116 of the front side of the frame, and in this condition the mobile carriage 71 is returned to the rear end-stop position by the weight of the door 6 on the inclined planes of the upper slots 45, thereby holding the spring 112, and returning it to its initial rest position in FIG. 9 in which it is predisposed for subsequent coupling to the bracket side 73, when the door is once again moved into this position and pressed for its closure. During the longitudinal sliding of the open door, which in the figure appears clearly positioned parallel on the front of a closed door 6′ of the cabinet, such door is guided at the top by the sliding of the wheels 46 along the relative longitudinal guide elements 55 and at the bottom by the sliding of the vertical 75 and horizontal wheels 78 and 79 along the longitudinal profile 69 of this door, and is therefore always kept in the correct parallel and orthogonal position. The door 6 may also slide with the same criteria along further longitudinal profiles 69 (not visible in the drawings) which are attached to the bottom of the cabinet in positions coinciding with those of the other doors of the cabinet, and which are positioned adjacent and aligned with the aforesaid longitudinal profile 69 of the door considered.

1. Support and operating device for sliding doors, in particular for wardrobe cabinets, suitable for determining the support and operating and sliding of the doors (6) in alternate longitudinal directions in positions coplanar to each other, wherein the doors (6) are actuated so as to shift from a closed position in which they are adjacent and aligned with each other and in relation to the front of the cabinet (5), to an open position wherein they are first shifted forwards by a limited stroke and then made to slide laterally into the desired position, parallel to the front face of the cabinet, and vice versa, wherein the cabinet (5) is delimited by a flat rear back (7), by two flat lateral sides (8, 9), by a flat upper top delimiting a free upper space with an underlying horizontal shelf (16), attached between the sides (8,9) and by a flat lower bottom (10) delimiting a free lower space with an underlying horizontal shelf (17), and wherein the doors 6 are fitted with handles (11,12) to move them from the closed position to the open position and vice versa, characterised by at least one upper group of component parts and one lower group of component parts for each door (6), respectively installed and attached in said upper free space and said lower free space, said upper group being substantially composed of support means (18) attached above said horizontal shelf (16) and supporting mobile means (22) suitable for supporting the upper part of each door (6), and sliding from a rear end-stop position in which the door (6) is moved into the lowered closed position, to a front end-stop position in which the door (6) is moved into the raised open position and shifted onto the front face of the cabinet (5), and vice versa, and wherein such sliding takes place by means of the guided sliding of said mobile means (22) along inclined planes (45), with downward inclination from the front to the rear of the cabinet (5), said mobile means (22) being stressed by first elastic means (61) supported by said support means (18) exerting a form of balancing on the door (6) during the movement thereof, which helps to maintain a correct parallel and orthogonal position of the door (6) in all the shifted positions thereof; characterised in that the upper part of said door (6) is shaped so as to be attached to said mobile means (22) and to contain first guide means (55) cooperating with second guide means (46) attached to said support means (18), to permit the alternate lateral sliding of the door, only when the same is moved into its open position; characterised in that said lower group is substantially composed of further support means (69) attached under said horizontal shelf (17), and by further mobile means (71) supported by said further support means (69) and cooperating with guide and slide means (70,75.78,79) attached to the lower part of said door (6), said further mobile means (71) being suitable for being shifted from a rear end-stop position, in which the door 6) is moved to the lowered closed position, to a front end-stop position in which the door (6) is moved into the raised open position, moved to the front of the cabinet (5) and vice versa, and wherein such sliding takes place by means of the guided sliding of said further mobile means (71) along inclined planes (103) with the same inclination, size and arrangement of the inclined planes (45) of said upper group, said further mobile means (71) being stressed by second elastic means (112) supported by the same and exercising on the door (6) a form of balancing during the movement thereof, which helps to maintain a correct orthogonal and parallel position of the door (6) in all the shifted positions thereof, in the condition in which the sliding position of said further mobile means (71) is constantly aligned and correspondent to the sliding position of said mobile means (22);
and lastly characterised in that said lower guide and sliding means (70, 75, 78,79,) of the door (6) are further co-operating with said further support means (69) to permit the alternate lateral sliding of the door, only when it is shifted to the open position.

2. Device according to claim 1, characterised in that said support means are composed of a metal box-like structure (18) formed of a flat bottom base (19), provided with a flat front rim (20) and a flat rear rim (21), and in the rear part of which said mobile means (22) are housed.

3. Device according to claim 2, characterised in that said mobile means comprise a siding or mobile carriage (22) formed of an elongated profile (23) of a parallelepiped shape, attached at its ends to a first and second flat profile element (24, 25), each of which is shaped with a central body (26) having a vertical extension, adaptable and attachable by means in themselves known against the corresponding end of the elongated profile (23) and with a lateral horizontal arm (27) forming a 1st class lever arm, and projecting from the central body (26) in a rear direction of the flat bottom (19), each flat profile element being shaped with a short lateral protrusion (29), projecting from said central body (26) in the opposite direction to that of the horizontal arm (27), said profile elements (24, 25) being fixed against the ends of the elongated profile (23), so that both horizontal arms (27) face the rear rim (21) of said bottom base (19) and their short protrusions (29) face towards said front rim (20), and between the horizontal lever arms (27) of both said profile elements there being applied and attached, to the respective ends thereof, a first and a second toothed reel (31, 32) of reduced diameter, identical to each other, which in turn are inserted and attached inside the relative lateral cavities of a rigid torsion bar (34) of an elongated cylindrical shape which is housed in a longitudinal direction of said bottom base (19) so that such torsion bar (34) can be actuated in rotation, together with the relative toothed reels (31, 32) in both its directions of rotation; and characterised in that each toothed reel (31, 32) is attached in a non-motorised manner in the torsion bar (34), and supported by said horizontal arm (27); that said lateral protrusions (29) support a relative slide wheel (37) in a non-motorised manner; that each end of said sliding or mobile carriage (22) is supported by a corresponding shaped side (39), appropriately laterally attached against the box-like structure (18); that said shaped sides (39) are each shaped with an inner surface fitted with two short rectilinear protrusions (41, 42) parallel and slightly distanced from each other, made at the relative toothed reels (31, 32), in the rear part of the flat bottom (19); that at least one of said rectilinear protrusions (41, 42) is provided with a plurality of teeth (43) having a profile and size identical to that of the teeth (44) of both toothed reels (31, 32,) and between the rectilinear protrusions (41, 42) said toothed reels, the teeth of which engage with the corresponding said teeth, are also adaptable; characterised in that each of said lateral sides (39) is shaped, in the part facing towards the front of the flat bottom, with an elongated through slot (45) constituting said inclined upper planes (45) and housing so as to slide the relative said sliding wheel (37) for the sliding thereof from the rear end-stop position to the front end-stop position, and vice versa; and further characterised in that in the front side of the elongated profile (23), facing towards said front rim (20), various non-motorised rotating wheels (47) are pivoted, identical and aligned and distanced from each other by the same interval, such wheels (47) being pivoted in positions staggered in a longitudinal direction in relation to the positions of said second guide means (46); and that beside the wheels (47) situated in the end positions an end stop (48) is respectively attached, composed of a relative disc (49) in soft material such as plastic, rubber etc, suitable for abutting against the inner surface of said front rim (20), when said sliding or mobile carriage (22) is moved into the front end-stop position, thereby dampening the impact between these component parts.

4. Device according to claim 3, characterised in that said first elastic means are composed of a balancing spring (61), preferably of the “constant force” type, one end of which winds and unwinds around a pin (62) attached under said elongated profile (23), and the other end of which is constrained to the arm (62) of a lever (64), hinged on said flat bottom (19), said arm being provided with a projecting lock (67) at its end to prevent the extraction of said spring (61) from the arm and presents a series of notches (68) to constrain the end of the spring in different positions along said arm, thereby varying the tension of the spring depending on the weight of the door (6) to be balanced each time.

5. Device according to claim 3, characterised in that each door (6) is fitted in the cabinet (5) by means of an elongated, weight-bearing profile (51) having the same length as the door and square-shaped, defining a flat rectilinear front side (52) extending in a vertical direction, and which is attached against the upper side of the door (6), and a horizontal rectilinear upper side (53), orthogonally bent in relation to the front side (52) and having an identical width to the length of said through slots (45) and therefore to the length of the stroke of said sliding or mobile carriage (22) in the transversal direction of said box-like structure (18), said horizontal upper side (53) being bent all along its length so as to define a recessed zone (54) facing downwards, the end portion of which is shaped to support and attach a corresponding longitudinal rectilinear profile (55), constituting said first guide means (55) and shaped underneath with a groove (58) all along its length, having a curved profile such as to house only said wheels (47) of said sliding or mobile carriage (22) when the latter is moved into its rear end-stop position, and to house such wheels (47) and also said second guide means (46), when this carriage 22 is moved into its forward end-stop position.

6. Device according to claim 5, characterised in that further box-like structures (18) are attached rearwards of each door (6) of the cabinet (5) and positioned adjacent and aligned with said box-like structure (18), to permit the sliding of each open door into different positions on the front of the closed doors, as far as the desired position.

7. Device according to claim 5, characterised in that said second guide means (46) are composed of various, non-motorised rotating wheels (46), pivoted inside said front rim (20), identical and aligned with each other by the same interval in the longitudinal direction of said box-like structure (18).

8. Device according to claim 1, characterised in that said further means of support (69) are composed of a rectilinear longitudinal profile (69) having the same width as the door (6) and which is applied to the lower flat bottom (10) and under the horizontal shelf (17) of the cabinet (5), at each door, said longitudinal profile (69) being shaped as a double T, defined by a flat and horizontal upper side (84) which is attached under said horizontal shelf (17), and by a lower flat and horizontal side (85) positioned parallel to the aforesaid upper side, as well as joined to it by means of a vertical and central side (86), said upper side (84) being bent downwards at the front by means of two short flat flaps (87, 88) facing each other and defining between them a free space for the sliding of said guide and sliding means (70, 75, 78, 79), said longitudinal profile (69) being provided with a central through aperture (89) shaped and scaled for the insertion of part of said further guide and sliding means (70) and of said further mobile means (71).

9. Device according to claim 8, characterised in that said guide and sliding means comprise a bracket (70) shaped with a flat vertical side (72) which is attached in the lower central part of the door (6), and connects by a series of steps orthogonally to a flat horizontal side (73), in which two sliding wheels (75) with a vertical axis are mounted laterally and from below, identical to each other and mounted free in rotation, in an aligned position to each other in the transversal direction of the side (73), so as to slide in a longitudinal direction along said free sliding space, on the upper surface of said horizontal side (73) two support plates (76, 77) also being applied and attached laterally, identical and symmetrical to each other, to support a relative wheel (78, 79) with horizontal axis, identical and parallel to each other, suitable for sliding along said free sliding space.

10. Device according to claim 9, characterised in that said further mobile means (71) comprise a mobile carriage (71) substantially composed of two lateral sides (96), identical and symmetrical to each other, suitable for being coupled in said through central aperture (89), and by a horizontal central frame (97) coupled between said sides (96) so as to slide with a limited stroke along the same; that said sides (96) are shaped to adapt and be opportunely attached with one end inside said through aperture (89), so that the sides are kept parallel to each other and are also provided with a corresponding inclined inner groove (103), which face each other and are made with the same inclination and of the same length as said through slots (45) forming said inclined lower planes (103), and the ends of said inclined planes (103) respectively defining the front end-stop and the rear end-stop of said central frame (97), which in turn is defined by two thin sides (104) parallel to each other and extending in a longitudinal direction of the mobile carriage (71) and by two further sides (105), parallel to each other and joined to the previous sides as well as extending in a transversal direction of the mobile carriage (71); that in the outer part of said longitudinal sides (104) a pair of non-motorised wheels (106) are respectively pivoted, with a horizontal rotation axis, identical to each other and suitable for being inserted so as to slide in the corresponding said inclined grooves (103) to thereby permit the sliding of the frame (97) in relation to said sides, said sides (96) being fitted internally with a series of inclined and projecting teeth (114), aligned with each other in a parallel position and above the relative inclined groove (103) of said sides; and that the front side (105) of said frame (97) is shaped so as to be coupled to the end rim (115) of the flat bracket side (73) when the door (6) is moved in relation to the mobile carriage (71) so that these parts come to coincide with each other, in such a way that said central frame (97) is always moved by the movement of said bracket (70) in the same shifted position of the latter, and during each movement of the bracket (70) it is stressed by the force of said second elastic means (112), which helps the balancing of the door during the movement thereof from the closed position the open position and vice versa, always keeping the door (6) in its correct parallel and orthogonal position, thanks to the fact that the sliding of the lower part of the door and the sliding of the upper part of the door always take place in synchrony with each other and in the same sliding positions along the respective sliding paths, in the condition in which, when said door (6) has been moved to the fully open position, it can be moved in the alternate longitudinal direction along said free sliding space, uncoupling from each other said bracket side (73) and said frame (97), and when said door (6) is closed or half open said bracket side (73) and said frame (97) are coupled to each other and the door cannot be made to slide in an alternate longitudinal direction.

11. Device according to claim 10, characterised in that said second elastic means comprise a longitudinal traction spring (112), one end of which attaches to a fixed attachment (111) provided in said central frame (97), and the other end of which couples to a rod (113) which is inserted in corresponding cavities of said inclined teeth (114), wherein the tension of said spring (112) may be varied, depending on the balancing needs, moving said rod (113) each time in a corresponding cavity of said inclined teeth (114).
